(19) United States
(12) Patent Application Publication
(10) Pub. No.: US 2002/0085960 A1
(43) Pub. Date: Jul. 4, 2002

(54) Array substrate holder

(75) Inventors: David Henninger, Pittsburgh, PA (US); Sara Cinnamon, Cambridge, MA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Genomic Instrumentation Services, Inc., San Carlos, CA

(21) Appl. No.: 09/999,761

(22) Filed: Nov. 1, 2001

Related U.S. Application Data
(60) Provisional application No. 60/245,864, filed on Nov. 2, 2000.

(51) Int. Cl. G01N 35/00; B01L 9/00

(52) U.S. Cl. 422/103; 422/104; 422/63

(57) ABSTRACT

The present invention is directed to a substrate holder adapted to immobilize a substrate relative to a platen or working surface of a scientific instrument such as, for example, a microarrayer apparatus. The substrate holder, in one embodiment, comprises a first plastic film interlayer in combination with the substrate and the platen, wherein the first plastic film interlayer is integrally interposed between the substrate and the platen. The present invention is also directed to a microarrayer apparatus that comprises an array substrate holder adapted to affix a substrate to a platen of the microarrayer apparatus. The present invention also provides methods for a affixing a substrate to a scientific instrument.

### CROSS-REFERENCE TO RELATED APPLICATION

This application claims the benefit of U.S. Provisional Patent Application No. 60/245,864 filed Nov. 2, 2000.

### BACKGROUND OF THE INVENTION

1. Field of the Invention

The present invention relates generally to biomolecular array technologies, and more specifically, to a substrate holder useful for affixing a substrate to a scientific instrument such as, for example, a microarrayer apparatus, as well as to methods related to the same.

2. Description of the Related Art

The emerging field of array technology is currently having an unprecedented impact on basic biology, biomedical research, biotechnology, and health care. In this regard, array technology has now made it possible to, among other things, measure various parameters of gene expression for entire genomes reliably and reproducibly. Thus, biomolecular arrays are now routinely used for the acquisition and analysis of the gene expression data (e.g., mutation detection, genotyping, proteomics, forensics, and pathology). Arrays of appropriately attached biomolecules may also be used in the identification and validation of new drug candidates.

As way of background, an array is understood by those skilled in the art to be a “substrate” to which selected biomolecules, generally DNA, RNA, cDNA, proteins or oligonucleotides, are attached (covalently or noncovalently) in a regular pattern of thousands of different spots. For purposes of illustration, a typical DNA array (drawn-to-scale) is provided in FIG. 1 (wherein the substrate is a chip such as, for example, a glass slide); and immediately below the illustrated full-scale chip is a blown-up schematic of the chip in which the regular array of different/distinct spots is more fully depicted. Within each of these spots, many biomolecules of an identical or unique sequence, structure or composition may be attached. A schematic of a single spot is shown to the right of the array. The squiggly lines in the circle represent individual nucleic acid molecules.

The most frequent type of reaction using DNA arrays is hybridization with labeled nucleic acid molecules. For this type of reaction, the chip is contacted with a solution containing labeled biomolecules, which hybridize to complementary sequences attached to the array. Hybridization is shown in FIG. 1 as a double squiggly line, and the label is represented by an asterisk. An instrument, such as a camera, is used to detect the label of the hybridized biomolecules. The lower left array in FIG. 1 has an asterisk for those areas that contain hybridized nucleic acids. However, if the immobilized nucleic acid molecules in a particular spot do not contain a complementary sequence to the labeled biomolecules, no hybridization occurs, and no label is detected. These areas are depicted in the figure as a dot.

Many of the patents directed to biomolecular arrays provide a long list of materials from which the underlying substrates may be composed of. However, in practice, silicon wafers (readily available from the semiconductor industry), borosilicate slides (e.g., microscope slides), and micro-well plates are presently the preferred materials that serve as array substrates. Silicon wafers as obtained from the semiconductor industry are particularly preferred because they are extremely pure, have an extremely flat surface, and are relatively cheap and readily available.

Irrespective of the substrate selected, a decision must also be made regarding how to attach or otherwise immobilize the selected biomolecules to the substrate (thereby forming a biomolecular array). In this context, a fundamental decision is whether to synthesize the biomolecules directly on the substrate (often termed in situ synthesis) or whether to synthesize the biomolecules separately and then position and attach them to the substrate (often termed post-synthetic attachment). At the present time, the primary technology for the in situ synthesis of arrays is photolithography, whereas the primary post-synthetic attachment technologies include ink jetting and mechanical spotting (ink-jetting involves the dispensing of the selected biomolecules to the target substrate using a dispenser derived from the ink-jet printing industry, whereas mechanical spotting involves the use of rigid pin tools coupled to a robotic microarrayer, wherein the microarrayer is capable of dispensing biomolecules and other reagents to the target substrate).

A significant problem associated with the manufacture of biomolecular arrays, however, involves affixing the target substrate to the microarrayer apparatus in such a way that the selected biomolecules may be readily attached. In the context of mechanical spotting through use of a robotic microarrayer, for example, target substrates are currently affixed to the platen or working surface of the robotic microarrayer by means of clamps (compression or screw-down), wherein the clamps apply sufficient pressure along one or more edges of the substrate to securely hold it in place. In another current approach, a vacuum is drawn through a plurality of holes that perpendicularly run through the platen or working surface, wherein the vacuum provides sufficient suction along the bottom surface of the substrate to securely hold it in place. In yet another approach, a double-faced piece of adhesive tape is interposed between the substrate and the working surface; this approach, however, is not optimal because commercially available adhesive tapes are not amenable to repeated substrate affixing procedures (i.e., the tape's adhesive qualities rapidly diminish with repeated affixing procedures, thereby rendering the tape ineffective for its intended purpose).

Although these above-mentioned techniques have been used to affix or otherwise immobilize substrates to microarrayer apparatuses (and other scientific instruments as well) with some degree of success, there is still a need in the art for new and improved substrate holders (especially in the context of array substrate holders), as well as to methods for affixing substrates to the platen or working surface of scientific instruments. The present invention fulfills these needs, and provides for additional advantages.

### BRIEF SUMMARY OF THE INVENTION

In brief, the present invention is directed to a substrate holder adapted to temporarily immobilize a substrate relative to a platen or working surface of a scientific instrument such as, for example, a microarrayer apparatus. The substrate holder, in one embodiment, comprises a first plastic interlayer in combination with a planar surface of the substrate and a planar working or platen surface of the scientific instrument, wherein the first plastic interlayer is a film or sheet, and wherein the first plastic interlayer is integrally interposed between the planar surface of the substrate and the planar working surface of the scientific instrument such that blocking occurs (1) between the planar surface of the substrate and the first plastic interlayer, and (2) between the first plastic interlayer and the planar working surface of the scientific instrument, and wherein the first plastic interlayer has no more than one applied adhesive layer on its faces.

The present invention also provides methods for temporarily affixing or otherwise immobilizing a substrate to a scientific instrument such as, for example, a microarrayer apparatus. Accordingly, and in one embodiment, a substrate may be affixed to the scientific instrument by providing the scientific instrument, wherein the scientific instrument comprises a platen or working surface having adhered thereto a first plastic film or sheet; and affixing the substrate onto the first plastic film or sheet.

The substrate holder and related methods of the present invention are more fully described in the context of the embodiments described and illustrated in the following detailed description.

### BRIEF DESCRIPTION OF THE SEVERAL VIEWS OF THE DRAWINGS

FIG. 1 schematically illustrates a DNA array, including a blown-up schematic of the array both before and after hybridization with labeled nucleic acid molecules, according to the prior art.

FIG. 2 is a perspective view of a work surface, a substrate, and a substrate holder according to an embodiment of the present invention.

FIG. 3 is an exploded perspective view of the work surface, substrate and substrate holder of FIG. 2.

FIG. 4 is an exploded perspective view of a work surface and an array substrate holder according to another embodiment of the present invention.

FIG. 5 is a sectional elevation view of a work surface, a substrate, and a substrate holder according to another embodiment of the present invention.

FIG. 6 is a sectional elevation view of a work surface, a substrate, and a substrate holder according to yet another embodiment of the present invention.

FIG. 7 is a sectional elevation view of a work surface, a substrate, and a substrate holder according to still another embodiment of the present invention.

FIG. 8 is a sectional elevation view of a work surface, a substrate, and a substrate holder according to still another embodiment of the present invention.

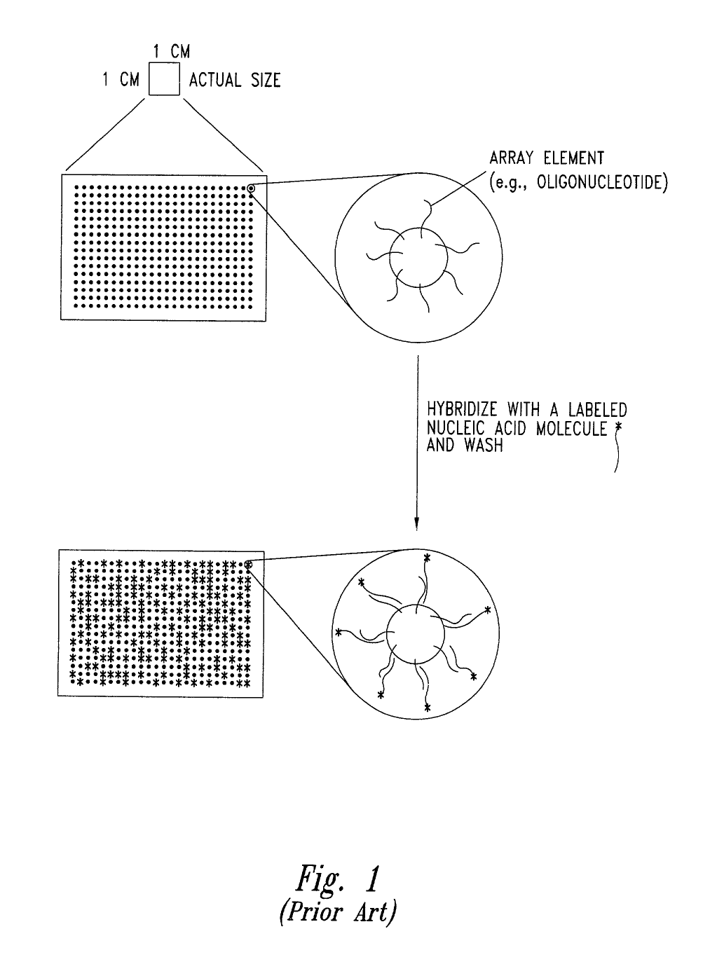

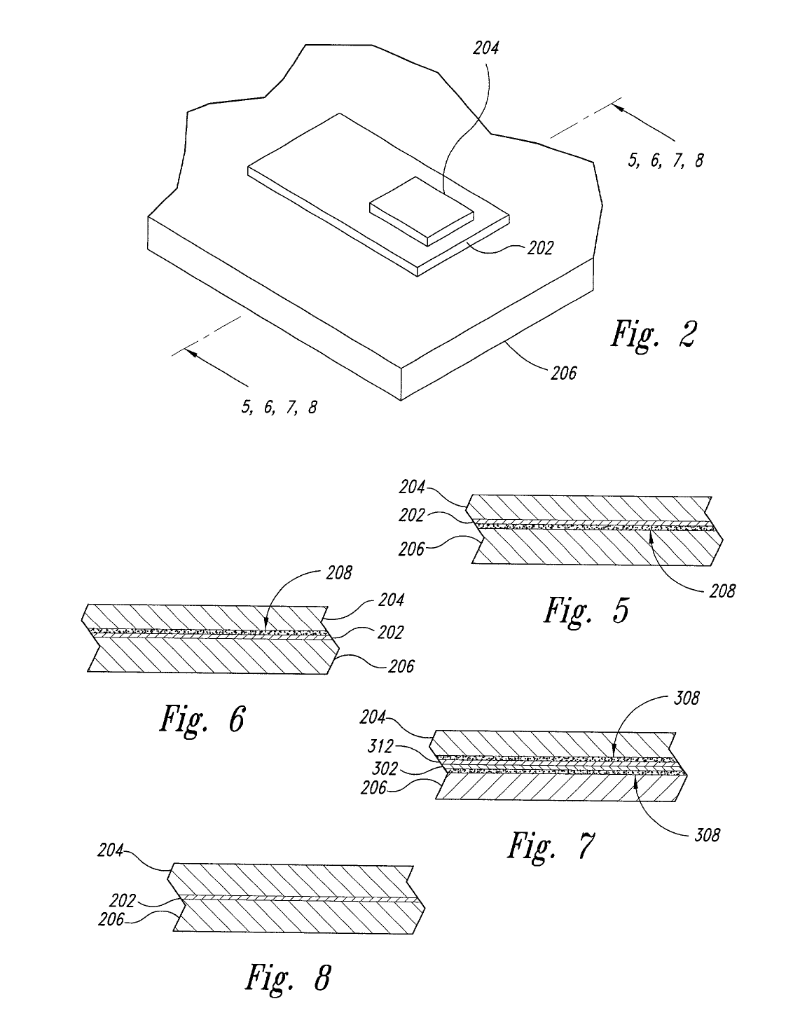

### DETAILED DESCRIPTION OF THE INVENTION

As noted above, the present invention is directed to a substrate holder adapted to temporarily immobilize a substantially planar surface of a substrate relative to a substantially planar working surface of a scientific instrument such as, for example, a working or platen surface of a microarrayer apparatus. Although many specific details of certain embodiments of the present invention are set forth in the following detailed description and accompanying Figures, those skilled in the art will recognize that the present invention may have additional embodiments, or that the invention may be practiced without several of the details described herein.

For purposes of clarity, a brief review of the nomenclature associated with plastic films and sheeting is helpful in understanding the full scope of the present invention. In general, a plastic is understood by those skilled in the art to be a synthetic organic solid material (such as, for example, celluloses, polyolefins, polyesters, and polyamides, as well as various combinations thereof) which can be readily shaped. Films, as that term is used in the polymer industry and in the context of the present invention, are shaped plastics that are comparatively thin in relation to their breadth and width, and have a maximum thickness (or gauge) of 0.010 inch (10 mils). Similarly, sheeting (sheet) is understood to be a shaped plastic having a thickness greater than 0.010 inch. (Films are therefore differentiated from sheeting only by thickness.) Tape is the term used for relatively narrow films that have had an adhesive layer applied (i.e., coated) to one or both of its faces, wherein the adhesive layer is understood to be any applied substance (e.g., cement, mucilage, glue, and paste) that is capable of holding materials together in a functional manner by surface attachment. A pressure sensitive tape is merely a tape that has at least one face that is permanently tacky at room temperature (usually by having an adhesive layer applied or coated thereon), and that will firmly adhere to a variety of dissimilar surfaces upon mere contact without the need of more than finger or hand pressure.

As is further appreciated by those skilled in the art, the tendency of plastic films or sheets to stick or adhere to each other, or to other surfaces, is referred to as “blocking.” In this regard, the American Society for Testing and Materials (ASTM) (Philadelphia, Pa.) has defined blocking as “an adhesion between touching layers of plastic, such as that which may develop under pressure during storage or use” (ASTM D 883-61T). The extent of blocking between adjacent plastic layers or other surfaces depends upon, among other things, temperature, pressure, and humidity, as well as upon the physical properties of the plastic itself. For example, if the plastic has a low softening point or if it picks up moisture readily, it will have a greater tendency to block than a plastic which has a high softening point and does not easily pick up moisture. In general, blocking may result from either or both of the following: (1) extremely smooth film or sheet surfaces, allowing intimate contact and nearly complete exclusion of air; and/or (2) pressure- or temperature-induced fusion of the surfaces in contact.

Specifications on blocking have been set up by the plastic film and sheeting industry, and methods have been developed to measure blocking under a variety of conditions (such methods include, for example, Blocking on Plastic Film, ASTM D 1893-61T; Blocking Point of Potentially Adhesive Layers, ASTM D 1146-63; Blocking Point of Paraffin Wax, ASTM D 1465-57T; Paper and Paper Board, ASTM D 1146-53, D 918-49; Tappi Standards, T-477 m-47, T-652 ts-61; Pressure Sensitive Tape Council, PSTC-1; all of such known methods are incorporated herein by reference in their entirety). In general, test methods for measuring the degree of blocking involve artificially producing blocking by means of a regulated high pressure applied to a specified number of plastic films or sheets stacked between two plates of steel (wherein the humidity and temperature are controlled), and after a prescribed period of time reducing the pressure, removing the plates, and determining the force required to pull the films or sheets apart. For the purpose of pulling the films or sheets apart and measuring the force needed, a Sutter tester or an Instron tester may be employed. The results may be measured in terms of unit force required to pull away a unit area of adhering film.

An alternative method for measuring the degree of blocking has also been established by the Pressure Sensitive Tape Council (PSTC) (Chicago, Illinois). More specifically, the PSTC has developed a test method known as PSCT-1 that is useful for determining blocking in terms of the peel adhesion value of a plastic film or sheet (Test Methods for Pressure Sensitive Adhesive Tapes, 12th edition, Pressure Sensitive Tape Council, Chicago, Ill., 1996; which publication is incorporated herein by reference in its entirety). In this test method, a plastic film or sheet test specimen (having approximate dimensions of about 1.0 inch in width by about 12.0 inches in length) is mechanically applied under controlled conditions (via a roller of known weight) to a cleaned flat test panel of stainless steel (i.e., stainless steel 302 or 304 having a bright annealed finish in accordance with ASTM Specification A 666). The force required to remove the plastic film or sheet test specimen from the test panel is known as the “peel adhesion value” and is customarily reported in ounces per 1 inch width to the nearest 1 oz./in. (Note that if other than 1 inch test specimen widths are tested, 1 inch values are found by dividing the observed value by the actual specimen width.)

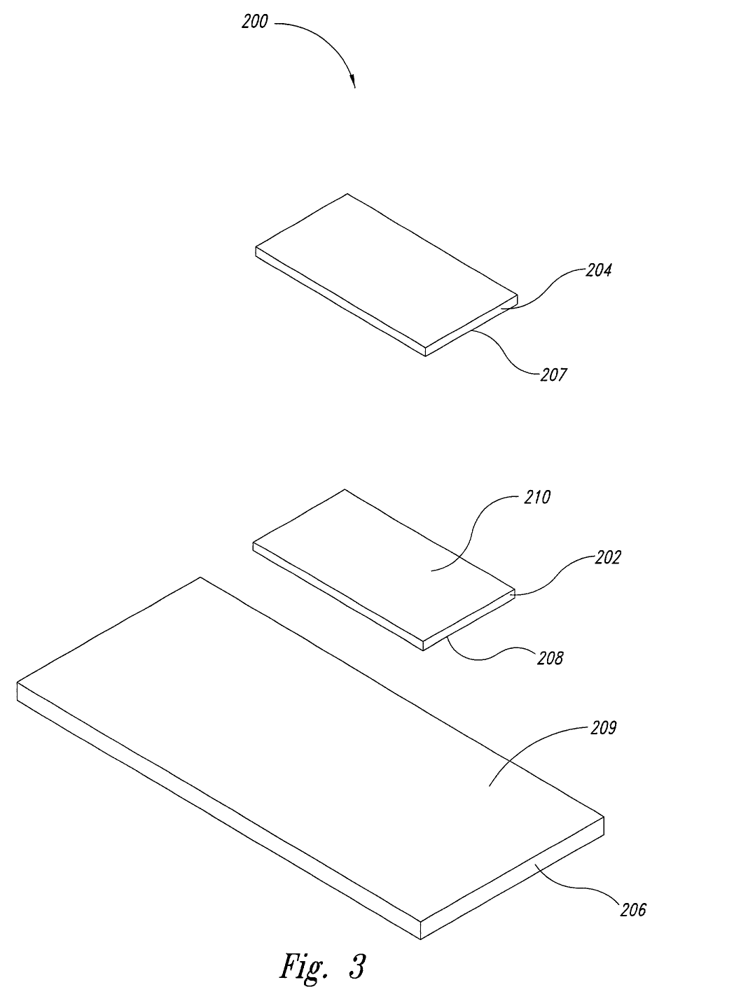

In view of the above-described nomenclature associated with plastic films and sheeting, the present invention is more fully described in the context of the following embodiments. Thus, in one embodiment (and as shown in FIG. 3) the substrate holder 200 comprises a first plastic interlayer 202 in combination with a substrate 204 and a platen or working surface 206 of a scientific instrument such as, for example, a microarrayer apparatus (not shown). The platen or working surface may be flat and made of anodized aluminum; however, the platen surface may be of a different construction such as, for example, a polished metal alloy or a smooth plastic. The microarrayer apparatus may be a robotic microarrayer such as, for example, the OMNIGRID Microarrayer sold by GeneMachines (San Carlos, Calif.). The platen or working surface of the OMNIGRID Microarrayer is flat and made of anodized aluminum with substrate containers magnetically affixed thereon. The substrate containers are also flat and made of anodized aluminum with a top and bottom surface. bottom surface. The bottom surface of the substrate container and the platen or working surface each have a layer of magnetic sheeting such that the substrate container and the platen or working surface are magnetically affixed to one another. The top surface has ridges spaced apart to accommodate and align glass slides, silicon chips or blot pads and the first plastic interlayer 202. One example of such a container and system can be seen at application Ser. No. 09/398,321, which is incorporated herein by reference in its entirety. The first plastic interlayer 202 may be a film or a sheet, and may made of materials such as, for example, celluloses, polyolefins, polyesters, and polyamides, as well as various combinations thereof.

Although FIG. 3 illustrates an exploded perspective view, it is to be understood that the first plastic interlayer 202 is integrally interposed between (i.e., intimately contacts) the substrate 204 and the platen 206 (see FIGS. 5-8 for sample configurations). More specifically, the first plastic film 202 may be in combination with a planar surface 207 of the substrate 204 and the planar working surface 209 of the scientific instrument, wherein the first plastic interlayer 202 is a film or a sheet, and wherein the first plastic interlayer 202 is integrally interposed between the planar surface 207 of the substrate 204 and the planar working surface 209 of the scientific instrument such that blocking occurs (1) between the planar surface 207 of substrate 204 and a top face 210 of the first plastic interlayer 202, and (2) between a bottom face 208 of the first plastic interlayer 202 and of the planar working surface 209 of the scientific instrument, and wherein the first plastic interlayer 202 has no more than one applied adhesive layer on either of its faces, 208, 210. As illustrated in FIGS. 5 and 6, it is appreciated that the first plastic film 202 can be adhered to either the substrate 204 or the planar working surface 209. Likewise, the first plastic film 202 can be integrally formed or otherwise fixed to the substrate 204 or the planar working surface 209. As illustrated in FIG. 8, the first plastic film 202 can be adhesiveless, and temporarily captively engaged with both the substrate 204 and the planar working surface 209 by blocking forces. Moreover, the first plastic film interlayer 202 may optionally have an applied adhesive surface 208 and an adhesiveless surface 210, wherein the applied adhesive surface is in contact with the platen and the adhesiveless surface is in contact with the substrate. As is appreciated by those skilled in the art, an adhesiveless surface denotes a surface that has little or no tackiness and that has not had an adhesive applied (i.e., coated) thereon, whereas an adhesive surface denotes a surface that has sufficient tackiness to enable the sticking together of the surface to a surface of a different material and wherein the surface has had an adhesive layer applied (i.e., coated) thereon. In addition, it is to be understood that the substrate may be, for example, a glass microscope slide, a silicon wafer, a blot pad or a micro-well plate.

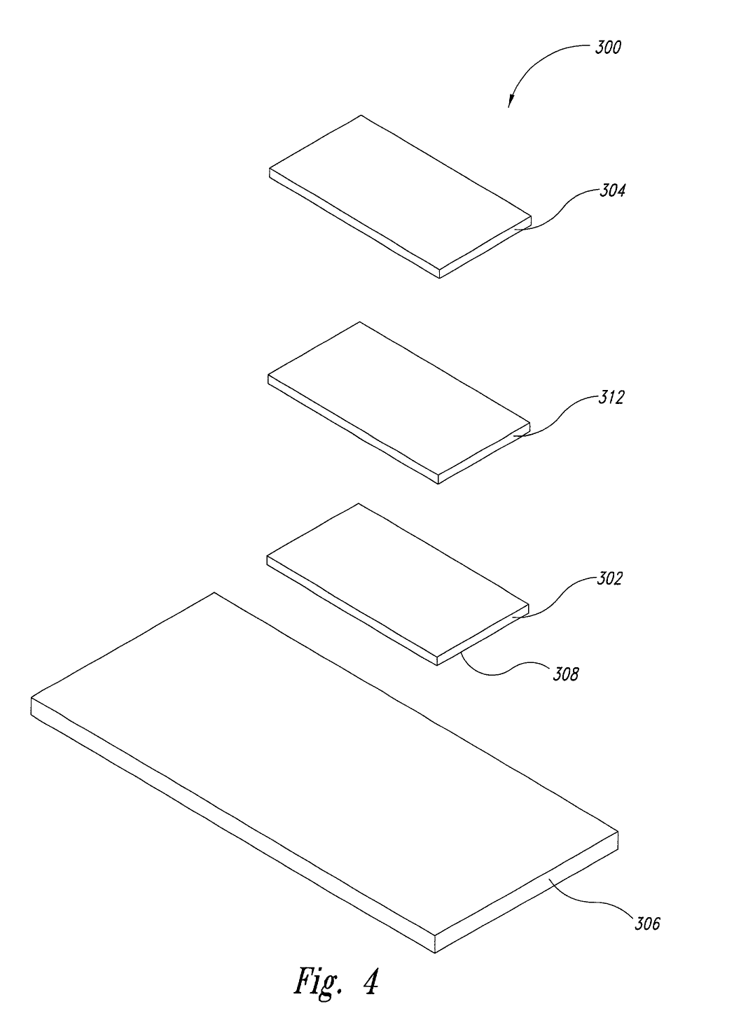

In another embodiment of the present invention (and as shown in FIG. 4), the array substrate holder 300 may further comprise a second plastic film interlayer 312, wherein the second plastic film interlayer 312 is integrally interposed between the substrate 304 and the first plastic film interlayer 302 (shown as an exploded perspective view). The second plastic film interlayer 312 preferably only has adhesiveless surfaces. In still further embodiments, the array substrate holder 300 may comprise a plurality of plastic film interlayers. In alternative embodiments, such as that illustrated in FIG. 7, the plurality of interlayers 302 can be adhered to the substrate 204 and/or the planar working surface 209, such as by an adhesive surface 308.

Exemplary of the plastic film interlayers are the “cling products” manufactured and sold by Transilwrap Company, Inc. (Chicago, Ill.). More specifically, such cling products include Transilwrap's flexible vinyl plastic films; namely, (1) TRANS-FLEX-CAST static cling vinyl having a peel adhesion value of at least about 8 oz./in. as determined by PSTC-1, (2) TRANS-CLING II low tack vinyl having a peel adhesion value ranging from about 8 to 16 oz./in. as determined by PSTC-1, (3) TRANS-STICK high tack vinyl having a peel adhesion value of at least about 24 oz./in. as determined by PSTC-1, and (4) STICK MATE, having a peel adhesion value of about 40 oz./in. as determined by PSTC-1. These flexible vinyl plastic films are available in a range of thickness and tackiness. In general, the thickness of these products range from about 0.002 inches to about 0.01 inches; whereas the tackiness of these products range from adhesiveless (e.g., TRANS-FLEXCAST static cling vinyl) to permanent adhesive (e.g., STICK MATE). All of these products are within the scope of the present invention, as are other types of plastic films such as, for example, plastic films of the polyester and polypropylene variety. In one embodiment, the first plastic interlayer is a STICK MATE permanent adhesive having a thickness of about 0.004 inches, and the second plastic interlayer is a TRANS-FLEX-CAST static cling vinyl having a thickness of about 0.008 inches. In addition, and as noted above, Transilwrap's flexible vinyl film products have peel adhesion values of at least about 8 oz./in. as determined by PSTC-1, and preferably ranging from about 8 oz./in. to about 40 oz./in. as determined by PSTC-1.

The present invention is also directed to a scientific instrument such as, for example, a microarrayer apparatus that comprises, in combination, any of the above-described array substrate holders. That is, the present invention is inclusive of scientific instruments and microarrayers that have a plastic film in combination with a substrate (e.g., glass microscope slide or a silicon wafer), wherein the plastic film is adhered or otherwise immobilized to the platen or working surface of the instrument or microarrayer and to the substrate. The working surface can include a platen with a substrate container magnetically affixed thereon.

The present invention is also directed to methods for affixing a substrate to a scientific instrument such as, for example, a microarrayer apparatus. In such methods, an instrument or a microarrayer apparatus is provided, wherein the microarrayer apparatus comprises a platen having adhered thereto a first plastic film. A second plastic film is affixed onto the first plastic film, and the substrate is affixed onto the second plastic film. As discussed above, the film can be bonded or adhered to the substrate or the working surface.

While the array substrate holder of the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

1. A substrate holder adapted to immobilize a substantially planar surface of a substrate relative to a substantially planar working surface of a scientific instrument, comprising:
a plastic interlayer in combination with the planar surface of the substrate and the planar working surface of the scientific instrument, wherein the plastic interlayer is a film or a sheet, and wherein the plastic interlayer is interposed between the planar surface of the substrate and the planar working surface of the scientific instrument such that blocking occurs both between the planar surface of substrate and the plastic interlayer, and between the plastic interlayer and the planar working surface of the scientific instrument, and wherein the plastic interlayer has no more than one adhesive layer on its opposing faces.

2. The substrate holder of claim 1 wherein the blocking that occurs between the planar surface of substrate and the plastic interlayer has a peel adhesion value of at least about 8 oz./in. as determined by PSTC-1.

3. The substrate holder of claim 1 wherein the blocking that occurs between the plastic interlayer and the planar working surface of the scientific instrument has a peel adhesion value of at least about 8 oz./in. as determined by PSTC-1.

4. The substrate holder of claim 1 wherein the blocking that occurs between the planar surface of substrate and the plastic interlayer has a peel adhesion value ranging from about 8 oz./in. to about 40 oz./in. as determined by PSTC-1.

5. The substrate holder of claim 1 wherein the blocking that occurs between the plastic interlayer and the planar working surface of the scientific instrument has a peel adhesion value ranging from about 8 oz./in. to about 40 oz./in. as determined by PSTC-1.

6. The substrate holder of claim 1 wherein the scientific instrument is a microarrayer apparatus.

7. The substrate holder of claim 1 wherein the plastic interlayer comprises a vinyl material.

8. The substrate holder of claim 1 wherein the plastic interlayer is a film.

9. The substrate holder of claim 8 wherein the film has thickness ranging from about 0.002 to about 0.01 inches.

10. The substrate holder of claim 1 wherein the plastic interlayer is a sheet.

11. The substrate holder of claim 10 wherein the sheet has thickness greater than 0.01 inches.

12. The substrate holder of claim 1 wherein the substrate is a silicon wafer, a borosilicate slide, a blot pad or a micro-well plate.

13. The substrate holder of claim 1 wherein the planar working surface of the scientific instrument comprises a metal.

14. The substrate holder of claim 1 wherein the planar working surface of the scientific instrument comprises a plastic.

15. The substrate holder of claim 1 wherein the planar working surface is of the same material as that of the plastic interlayer.

16. The substrate holder of claim 1 wherein the planar working surface of the scientific instrument is comprised of a platen and a substrate container wherein the substrate container is integrally interposed between the platen and the plastic interlayer and is affixed to the platen by magnetic forces.

17. The substrate holder of claim 15 wherein the substrate container has a top and a bottom portion, the bottom portion is adapted to magnetically affix itself with the platen and the top portion comprises ridges spaced apart to accommodate standard microscope slides, silicon chips or blot pad and the plastic interlayer.

18. The substrate holder of claim 1 wherein the plastic interlayer is a first plastic interlayer, and further comprising a second plastic interlayer interposed between the planar surface of the substrate and the planar working surface of the scientific instrument, and wherein the second plastic interlayer is a film or a sheet.

19. The substrate holder of claim 1 wherein the plastic interlayer is a first plastic interlayer, and further comprising a plurality of second plastic interlayers interposed between the planar surface of the substrate and the planar working surface of the scientific instrument, wherein the plurality of second plastic interlayers are films or sheets, or a combination thereof.

20. A microarrayer apparatus that includes a substrate holder adapted to immobilize a substantially planar surface of a substrate relative to a substantially planar working surface of the microarrayer, the substrate holder comprising:
a plastic interlayer in combination with the planar surface of the substrate and the planar working surface of the scientific instrument, wherein the plastic interlayer is a film or sheet, and wherein the plastic interlayer is integrally interposed between the planar surface of the substrate and the planar working surface of the scientific instrument such that blocking occurs both between the planar surface of substrate and the plastic interlayer, and between the plastic interlayer and the planar working surface of the scientific instrument, and wherein the plastic interlayer has no more than one applied adhesive layer on its opposing faces.

20. The microarrayer apparatus of claim 19 wherein the planar working surface of the scientific instrument is comprised of a platen and a substrate container wherein the substrate container is integrally interposed between the platen and the plastic interlayer and is affixed to the platen by magnetic forces.

21. The microarrayer apparatus of claim 20 wherein the substrate container has a top and a bottom portion, the bottom portion is adapted to magnetically affix itself with the platen and the top portion comprises ridges spaced apart to accommodate standard microscope slides, silicon chips or blot pad and the plastic interlayer.

22. A method for a affixing a substrate to a scientific instrument comprising the steps of:
providing the scientific instrument, wherein the scientific instrument comprises a platen or working surface having adhered thereto a plastic film or sheet; and
affixing the substrate onto the plastic film or sheet in a manner such that blocking occurs between the plastic film or sheet and the substrate.
